(19) United States
(12) Patent Application Publication
(10) Pub. No.: US 2009/0033265 A1
(43) Pub. Date: Feb. 5, 2009

(54) Monitoring Unit for Monitoring the Load of an Electric Motor

(76) Inventors: Roland Fleischmann, Gossweinstein (DE); Peter Harmsen, Schwarzenfeld (DE); Martin Maier, Erbendorf (DE)

Correspondence Address: HARNESS, DICKEY & PIERCE, P.L.C., P.O.BOX 8910, RESTON, VA, 20195, US

(21) Appl. No.: 12/085,521

(22) PCT Filed: Nov. 29, 2005
(86) PCT No.: PCT/DE2005/002152

§ 371 Date: Jun. 17, 2008

(51) Int. Cl. H02P 23/00

(52) U.S. Cl. 318/434

(57) ABSTRACT

A monitoring unit is disclosed for monitoring the load of an electric motor. In at least one embodiment, the monitoring unit provides for the motor load to be monitored over the entire torque range. For this purpose, the monitoring unit uses linearizing matching of the indication variable. First, the monitoring unit is provided for detecting a motor current and a phase angle between the supply voltage and the motor current in the operating state of the motor. Furthermore, it includes at least one device for forming an indication variable from the motor current and the phase angle as a measure for monitoring the electric load of the motor.

### PRIORITY STATEMENT

This application is the national phase under 35 U.S.C. § 371 of PCT International Application No. PCT/DE2005/002152 which has an International filing date of Nov. 29, 2005, which designated the United States of America, the entire contents of which are hereby incorporated herein by reference.

### FIELD

At least one embodiment of the invention generally relates to a monitoring unit and/or to a method for monitoring the load of an electric motor.

### BACKGROUND

A monitoring unit and a method are used in conjunction with motors and drives, in particular for drives and motors which are integrated in automation installations.

Such a monitoring unit may, for example, be in the form of an electronic monitoring relay. The monitoring unit generally has a measurement unit, which measures a load-relevant variable. Furthermore, an evaluation unit evaluates the measured variable so as to ensure, for example, that a load of a motor or of a drive is monitored.

One load-relevant variable is represented, for example, by the motor current I or the power factor cos φ of a drive or of a motor. Threshold values are generally set for the load-relevant variable for the load monitoring relays, and a switching relay is operated if these threshold values are undershot or overshot.

By way of example, the power factor cos φ may be used as a load-relevant variable, with φ representing the phase angle between the supply voltage for the drive and the motor current flowing in this case. The power factor cos φ can then be monitored by means of preset thresholds. It is likewise possible to set a tolerance band.

Furthermore, the motor current is also used as a load-relevant variable for monitoring, in practice. The load-relevant variable is generally related to the motor torque. This results in a direct association between the load-relevant variable and the motor torque.

In consequence, the load-relevant variable acts as an indication of the currently available motor torque. In this context, it is desirable for the load-relevant variable to be linearly related to the torque, in as many torque ranges as possible. Unfortunately, this is generally not the case.

Irrespective of which variable is chosen as the load-relevant variable, the relationship between the load-relevant variable and the motor torque is in no way linear. This means that the load-relevant variable is calculated incorrectly in quite specific torque ranges. In consequence, the load-relevant variable is no longer suitable for monitoring the load of the motor or of the drive in these ranges. In consequence, the definition of the tolerance band or the definition of the thresholds is restricted to quite specific torque ranges. Linearization of the load-relevant variable over the entire torque range would allow free tolerance-band and threshold selection.

FIG. 1 shows load-relevant variables such as the motor current, which has already been mentioned, and the cosine of the phase angle φ plotted against the motor torque. If the motor current is chosen as a load-relevant variable, then the curve K1 with the associated scale in amperes on the right-hand side is relevant. For relatively high torques, this load-relevant variable has an essentially linear profile. At lower torques, in contrast, this curve appears to flatten out, and therefore reduces the validity or the decision power resulting from use of the motor current as a load-relevant variable. If, in contrast, the phase angle is chosen as a load-relevant variable, then the curve K2 is relevant.

The associated vertical axis is shown on the left-hand side of the graph. In this case, the load-relevant variable extends from 0 to 1. In comparison to the use of the motor current as a load-relevant variable, this results in the opposite problem. The curve which is based on the phase angle has a comparatively linear relationship at relatively low torques, but flattens out ever more at higher torques. In consequence, it is difficult and erroneous to set thresholds and tolerance bands in the range of higher torques. In consequence, neither the use of the motor current nor the use of the phase angle as load-relevant variables allow a curve to be produced which is linear over the entire torque range, and which could therefore be used for correct load monitoring.

The described methods for loading monitoring have the following disadvantages:

Appliances which are in existence at the moment can no longer carry out a defined measurement at no-load currents below 0.5 A, and operate only on a mains rated voltage. In consequence, evaluation does not lead to any result and makes monitoring at low no-load currents impossible.

Until now, the principle of the quiescent current and the delay time have been combined in order to ensure load monitoring during the motor starting process. Additional logic, for example a programmable logic controller PLC, is required for this purpose when the aim is to electrically include the load monitoring relay upstream of the contactor in the motor branch, after application of the mains voltage. It is desirable for it to be possible to also electrically connect the load monitoring relay in a motor branch upstream of the switch-on/off contactor, without additional logic. To do this, it is necessary to start the starting bridging time for the drive only after current has started to flow. Since it is not possible to record the motor current at very low current levels, use must always be made of further additional logic.

EP 0 788 210 A1 discloses an electronic relay which isolates a variable based on the phase angle by way of a measurement unit, and uses this for load monitoring by means of a microprocessor.

### SUMMARY

At least one embodiment of the invention specifies a monitoring unit for monitoring the load of an electric motor, wherein threshold values for monitoring can be set linearly over virtually the entire torque range of the motor.

In at least one embodiment, a monitoring unit is disclosed which is intended to record the motor current and the phase angle between the supply voltage and the motor current in the operating state of the motor, and which includes a device for formation of an indication variable from the motor current and the phase angle as a measure for monitoring the electrical load of the motor. In at least one embodiment, a method is disclosed, in which the motor current and the phase angle between the supply voltage and the motor current in the operating state of the motor are recorded, and an indication variable is formed from the motorcurrent and the phase angle as a measure for monitoring the electrical load of the motor.

According to at least one embodiment of the invention, the monitoring unit records both the motor current and the phase angle between the supply voltage and the motor current. Both variables are also processed after being recorded in an evaluation unit, or functions or indication variables are formed, based on the recorded motor current and phase angle. The monitoring unit includes at least one device for formation of an indication variable from the motor current and the phase angle. The indication variable is in this case based on the motor current and the phase angle, in which case both recorded variables are for this purpose processed for example by further mathematical or electrical functions. The indication variable is used as a measure for monitoring the electrical load of the motor. The indication variable is chosen such that the relationship between the indication variable and the torque or load of the motor is linear. Furthermore, the at least one device for formation of an indication variable can be adapted for continuous matching to the characteristic properties of the motor to be monitored. Active linear adaptation of the indication variable is therefore possible for further optimization or for adjustment for different motors or drives.

A further advantageous embodiment of a monitoring unit for load monitoring uses an indication variable which is formed from the product of the motor current and the cosine of the phase angle. Since the two load-relevant variables have different accuracy in the various load and torque ranges, a compensation effect results in linearization by the use of this product of the motor current and the cosine of the phase angle. Furthermore, combinations of other load-relevant variables are feasible, which result in a mutual compensation effect that leads to linearization of the relationship between the indication variable and the torque or the load.

The indication variable can advantageously be formed from the product of a first function, which is formed from the motor current, and a second function, which is formed from the phase angle. Further inclusion of electronic or mathematical functions allow the recorded load-relevant variables of the motor current and phase angle to be conditioned by way of a first and/or a second function further such that the linear adaptation is further optimized. Further linearization leads to a direct relationship between the indication variable and the instantaneous motor load being ensured.

The monitoring unit is advantageously intended to initiate at least one protective measure if at least one threshold value and/or one tolerance band of the integration variable is overshot or infringed. This is a conventional procedure, but in conjunction with the linearized indication-variable/torque characteristic, it leads to the capability to better adjust the threshold values, and therefore to more direct monitoring of the motor. Furthermore, the linearized characteristic extends the monitoring range of the motor from very low switch-on currents up to high motor currents when driving a peak load.

The extended recording range and a wide voltage supply allow the monitoring unit to be used universally. Furthermore, the monitoring unit in this case does not require any additional logic circuitry, in the form of a PLC, if the monitoring unit is arranged electrically upstream of the contactor in the motor outgoer. This has positive effects which are significant for other appliances. For example, the voltage supply for the monitoring unit can be designed not only for a rated voltage with a tolerance (for example 400 V AC±10%) but it is also possible to produce a wide-voltage version with an operating range from, for example, 90 V AC to 690 V AC.

Further advantageous embodiments and preferred developments of the invention can be found in the description of the figures and/or in the dependent claims.

### BRIEF DESCRIPTION OF THE DRAWINGS

The invention will be described and explained in more detail in the following text with reference to the example embodiments which are illustrated in the figures, in which:

FIG. 1 shows a graph illustrating possible indication variables as a function of the motor torque, and

FIG. 2 shows a block diagram of one example embodiment of a monitoring unit.

### DETAILED DESCRIPTION OF THE EXAMPLE EMBODIMENTS

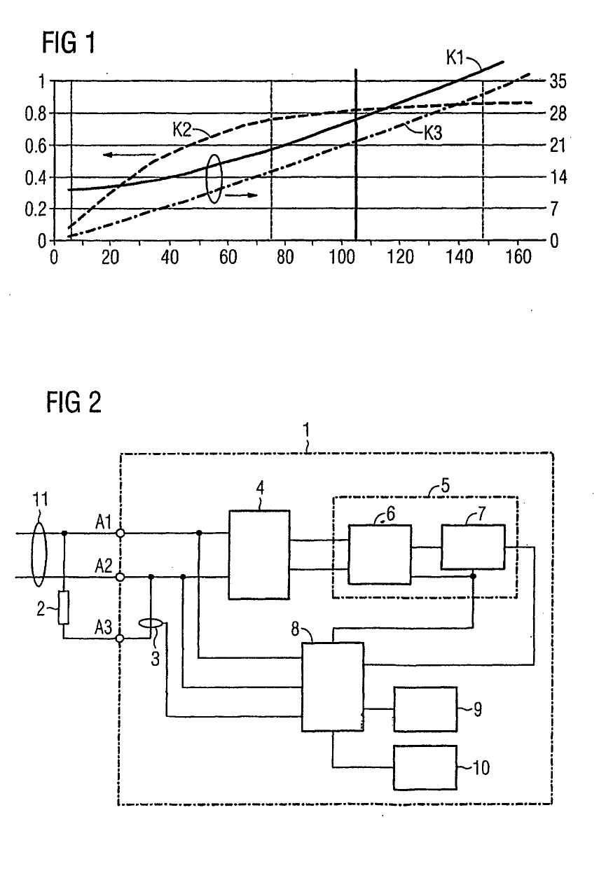

FIG. 1 shows a graph illustrating possible indication variables as a function of the motor torque. The left-hand vertical axis should be seen in conjunction with the curve K2, which is based on an indication variable based on the cosine of the phase angle. As has already been mentioned in the introduction, the curve K2 has a virtually linear profile at low motor torques, but appears to flatten out at medium and higher torques, making reliable monitoring and reliable initiation of protective measures impossible. As can be seen in FIG. 1, possible monitoring is no longer feasible above about 75% of the rated motor torque (indicated by the vertical bar printed in bold). This means that the remaining 25% of the torque range cannot be monitored.

The graph in FIG. 1 also shows the curve K1 which represents an indication variable as a function of the torque, based on the motor current. The right-hand vertical axis is relevant for the curve K1. If the motor current is chosen as the basic variable for the indication variable, there is no linear relationship between the indication variable and the motor torque at low torques. The threshold values and tolerance bands can therefore be set correctly only to a restricted extent. Once again, a restriction to the monitoring range must be accepted.

The already discussed indication variables of the curves K1, K2 are known from the prior art.

According to an embodiment of the invention, this example embodiment proposes an indication variable which is formed from the motor-current variable in combination with the phase-angle variable. In this example embodiment, the indication variable includes the product of the motor current and the cosine of the phase angle. The indication variable according to the invention is shown in the form of the curve K3 in the graph in FIG. 1. The right-hand vertical axis is relevant in conjunction with K3. As can clearly be seen, the problem areas of the indication variables based on only one of the two load-relevant variables have been compensated for. A virtually linear relationship has been achieved for the indication variable relating to the motor or drive torque, in which there are no problem areas. This allows thresholds or tolerance bands to be defined over the entire torque range without the direct reference between the indication variable and the torque having a negative effect on load monitoring.

The linearization makes it possible, for example, to correctly detect a V-belt being torn, a pump running on no load, the load on a conveyor belt, or tool wear. This makes it possible to avoid consequential damage in installations, in particular automation installations.

Furthermore, no additional programmable logic controllers are required to allow the entire torque range to be monitored.

FIG. 2 shows a block diagram of one example embodiment of a monitoring unit 1. The monitoring unit 1 has two phase connections A1 and A2 which are intended for electrical connection to a respective phase of a polyphase electrical power supply system 11. The motor 2 to be monitored is in this case connected on the one hand to one of the phases of the electrical power supply system 11, and on the other hand to the connection A3 of the monitoring unit 1.

In this example embodiment, the monitoring unit 1 is in the form of a two-phase appliance. By way of example, the phase connections A1 and A2 can be connected to the phases L1 and L2, or else to a phase Lx (where X=1, 2, or 3) and N (neutral conductor). The circuit in which the motor 2 to be monitored is located runs partially through the monitoring unit 1. The motor 2 is connected not only to the phase L1 but also via the monitoring unit to the phase L2. The motor current of the motor 2 is measured by means of a current sensor 3. In this case, the current sensor 3 may be a current transformer, which maps the motor current onto a voltage interval. This mapped voltage is passed on via a line to the measurement and assessment unit.

The measurement and assessment unit 8 is also connected to the phases L1 and L2 and is therefore able to record the motor current and the phase angle between the motor current and the supply voltage. The measurement and assessment unit 8 can be formed, for example, from a controller with the peripheral associated with it. The measurement and assessment unit 8 is supplied with voltage by the voltage regulation 5.

The voltage regulation 5 contains a switched-mode regulator 6 and a high-voltage stage 7. The voltage regulation is supplied with DC voltage from a rectifier, for example a bridge rectifier.

The measurement and assessment unit 8 assesses the measured variables and/or carries out an initial analysis. The measurement and assessment unit 8 is able to use the switching stage 10, which contains at least one relay, to carry out protective disconnection or protective connection. The decision for a protective reaction is initiated on the basis of the indication variable/torque characteristic.

Furthermore, the indication variable formation process can be optimized by way of the diagnosis and indication unit 9. The diagnosis and indication unit 9 may, for example, be in the form of a control section printed circuit board. The user can therefore integrate in a characteristic motor-specific or application-specific characterizing features which are relevant for a protective disconnection or protective connection. The change in a characteristic in this case results in a change in the method of calculation of the integration variable. The important factor is that this calculation is always based both on the determined motor current and on the determined phase angle.

In summary, at least one embodiment of the invention relates to a monitoring unit for monitoring the load of an electric motor. The monitoring unit ensures that the motor load is monitored over the entire torque range. The monitoring unit adapts the indication variable in order to linearize it for this purpose. First of all, the monitoring unit is intended to record the motor current and the phase angle between the supply voltage and the motor current in the operating state of the motor.

Furthermore, it has at least one device for formation of an indication variable from the motor current and the phase angle as a measure for monitoring the electrical load of the motor.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A monitoring unit for monitoring the electrical load of an electric motor, the monitoring unit being useable to record a motor current and a phase angle between a supply voltage and the motor current in an operating state of the motor, the monitoring unit comprising:
at least one device to form an indication variable from the motor current and the phase angle as a measure for monitoring the electrical load of the motor, the indication variable being chosen so that a threshold value is associateable with a torque of the motor within a torque interval defined by a minimum possible torque and a maximum possible torque.

2. The monitoring unit as claimed in claim 1, wherein the indication variable is formed from the product of the motor current and a cosine of the phase angle.

3. The monitoring unit as claimed in claim 1, wherein the indication variable is formed from a product of a first function, formed from the motor current, and a second function, formed from the phase angle.

4. The monitoring unit as claimed in claim 1, wherein the indication variable is essentially linearly related to the torque of the motor.

5. The monitoring unit as claimed in claim 1, wherein the indication variable is essentially proportional to the electrical load of the motor.

6. The monitoring unit as claimed in claim 1, wherein the monitoring unit is useable to set at least one of a threshold value and a tolerance band of the indication variable in order to initiate at least one protective measure.

7. A method for monitoring the electrical load of an electric motor, comprising:
recording a motor current and a phase angle between a supply voltage and a motor current in an operating state of the motor; and
forming an indication variable from the motor current and the phase angle as a measure for monitoring the electrical load of the motor, wherein at least one of a threshold value and a tolerance band of the indication variable are associated with a torque of the motor within a torque interval defined by a minimum possible torque and a maximum possible torque.

8. The method as claimed in claim 7, wherein the indication variable is formed from a product of the motor current and a cosine of the phase angle.

9. The method as claimed in claim 7, wherein the indication variable is formed from a product of a first function, formed from the motor current, and a second function, formed from the phase angle.

10. The method as claimed in claim 7, wherein the indication variable is essentially linearly related to a torque of the motor.

11. The method as claimed in claim 7, wherein the indication variable is essentially proportional to the load of the motor.

12. The method as claimed in claim 7, wherein at least one of the threshold value and tolerance band of the indication variable is set in order to initiate at least one protective measure.

13. (canceled)

14. (canceled)

15. The monitoring unit as claimed in claim 2, wherein the indication variable is formed from a product of a first function, formed from the motor current, and a second function, formed from the phase angle.

16. The method as claimed in claim 8, wherein the indication variable is formed from a product of a first function, formed from the motor current, and a second function, formed from the phase angle.

17. A monitoring unit for monitoring the electrical load of an electric motor, comprising:
means for recording a motor current and a phase angle between a supply voltage and a motor current in an operating state of the motor; and
means for forming an indication variable from the motor current and the phase angle as a measure for monitoring the electrical load of the motor, wherein at least one of a threshold value and a tolerance band of the indication variable are associated with a torque of the motor within a torque interval defined by a minimum possible torque and a maximum possible torque.

18. The monitoring unit as claimed in claim 17, wherein the indication variable is formed from a product of the motor current and a cosine of the phase angle.

19. The monitoring unit as claimed in claim 17, wherein the indication variable is formed from a product of a first function, formed from the motor current, and a second function, formed from the phase angle.

20. The monitoring unit as claimed in claim 17, wherein the indication variable is essentially linearly related to a torque of the motor.

21. The monitoring unit as claimed in claim 17, wherein the indication variable is essentially proportional to the load of the motor.

22. The monitoring unit as claimed in claim 17, wherein at least one of the threshold value and tolerance band of the indication variable is set in order to initiate at least one protective measure.
